(19) United States
(12) Patent Application Publication
(10) Pub. No.: US 2010/0318444 A1
(43) Pub. Date: Dec. 16, 2010

(54) METHODS AND SYSTEMS FOR PURCHASING AND SELLING GOODS VIA MOBILE COMPUTING DEVICES

(76) Inventor: KAMAL SAIFUL QUADIR, Lexington, MA (US)

Correspondence Address: BROWN RUDNICK LLP, ONE FINANCIAL CENTER, BOSTON, MA, 02111, US

(21) Appl. No.: 12/779,490

(22) Filed: May 13, 2010

Related U.S. Application Data
(60) Provisional application No. 61/177,833, filed on May 13, 2009.

(51) Int. Cl. G06Q 30/00

(52) U.S. Cl. 705/27.1

(57) ABSTRACT

Methods of purchasing and selling goods via mobile computing devices connected to a communications network. A method of purchasing and selling goods includes transmitting data received from a first mobile computing device and a second mobile computing device in response to a request to purchase or sell a good offered for sale.

### CROSS-REFERENCE TO RELATED APPLICATION

This patent application claims priority to U.S. Provisional Application Ser. No. 61/177,833, filed in the U.S. Patent and Trademark Office on May 13, 2009, the entire contents of which are hereby incorporated by reference in its entirety.

### TECHNICAL FIELD

The invention generally relates to methods and systems for purchasing and selling goods via mobile computing devices, and, more particularly, to the generation of a marketplace among users of mobile computing devices by means of various wireless messaging paradigms.

### BACKGROUND

In developing countries, limited communication technology hinders business because traveling great distances is the only way to get market information. Isolated and uninformed, farmers, traders, and businesses have no bargaining power with middlemen. Those living in large swaths of the developing world have no access to the Internet or to anything even approaching the benefits of a true, modern electronic market.

In such countries, alternative ways of gathering market price information and connecting buyers and sellers consist of (a) traveling in person to a local marketplace or to an individual farmer, or (b) calling a handful of potential buyers or sellers to determine the demand, availability, and price for various goods to provide a sample of the total market. Accordingly, these alternatives are time-consuming, costly, inaccurate, and represent one-to-one access.

### SUMMARY OF THE INVENTION

The invention relates to methods and systems for purchasing and selling goods via mobile computing devices. Methods and systems according to the invention introduce a wireless marketplace using existing and rapidly expanding mobile phone platforms. This is accomplished, for example, by buyers and sellers communicating over their mobile phone in order to conduct business on their mobile handsets. A seller is able to post a good for sale via their mobile phone while an interested buyer can purchase that good over their mobile phone as well. In contrast to the existing market structure in many countries, the methods and systems according to the invention allow a seller and buyer to use their mobile phones to check market prices, sell and buy their products, see information that can be leveraged to attain favorable prices, or make an informed decision about traveling to the market.

In one aspect, the invention relates to a method of purchasing and selling goods via mobile computing devices connected to a communications network. The method includes providing a first mobile computing device and a second mobile computing device each having a user interface component for displaying data, the data identifying at least one good offered for sale by a first party; transmitting the data via the communications network to a server, the server including a central processing unit, a memory connected to the central processing unit, and a data storage medium for storing the data; receiving a request to purchase at least one good via the second mobile computing device; and generating a notification message to send to the first party indicating the willingness of a second party to purchase the at least one good.

In one embodiment according to this aspect of the invention, each of the first mobile computing device and the second mobile computing device is selected from a group consisting of a mobile phone, a smart phone, a personal digital assistant, a web-based mobile client, and a wireless application protocol client.

In another embodiment according to this aspect of the invention, the notification message can be a short message service message, a wireless application protocol message, or a world-wide-web based message.

In another embodiment according to this aspect of the invention, the method can further include removing the at least one good offered for sale from the communications network. The method can also include requesting feedback from the first party regarding the sale of the at least one good. The method can further include requesting feedback from the second party regarding the purchase of the at least one good. The method can also include logging in to a subscription service of the communications network prior to receiving the data from the first mobile computing device.

In a second aspect, the invention relates to a method of purchasing and selling goods via mobile computing devices connected to a communications network. The method includes providing a first mobile computing device and a second mobile computing device each having a user interface component for displaying data, the data identifying at least one good offered for sale by a first party; transmitting the data via the communications network to a server, the server including a central processing unit, a memory connected to the central processing unit, and a data storage medium for storing the data; processing the data to generate a listing of a plurality of goods; receiving a request to purchase at least one of the plurality of goods via the second mobile computing device; and generating a notification message to send to the first party indicating the willingness of a second party to purchase the at least one good, the first party receiving the notification message and replying affirmatively to the request to purchase the at least one good.

In one embodiment according to this aspect of the invention, the notification message can be a short message service message, a wireless application protocol message, or a world-wide-web based message.

In another embodiment according to this aspect of the invention, each of the first mobile computing device and the second mobile computing device is selected from a group consisting of a mobile phone, a smart phone, a personal digital assistant, a web-based mobile client, and a wireless application protocol client.

In a third aspect, the invention relates to a method of purchasing and selling goods via mobile computing devices connected to a communications network. The method includes providing a first mobile computing device and a second mobile computing device each having a user interface component for displaying data, the data identifying at least one good offered for sale by a first party; transmitting the data via the communications network to a server, the server including a central processing unit, a memory connected to the central processing unit, and a data storage medium for storing the data; logging in to a subscription service of the communications network via the first mobile computing device to provide secure access for the first mobile computing device; logging in to a subscription service of the communications network via the second mobile computing device to provide secure access for the second mobile computing device; selecting the at least one good via the second mobile computing device by specifying a price, a description, or a location of the at least one good; receiving a request to purchase the at least one good via the second mobile computing device; and generating a notification message to send to the first party indicating the willingness of a second party to purchase the at least one good, the first party receiving the notification message and replying affirmatively to the request to purchase the at least one good.

In one embodiment according to this aspect of the invention, the notification message can be a short message service message, a wireless application protocol message, or a world-wide-web based message. In another embodiment according to this aspect of the invention, each of the first mobile computing device and the second mobile computing device is selected from a group consisting of a mobile phone, a smart phone, a personal digital assistant, a web-based mobile client, and a wireless application protocol client. In another embodiment according to this aspect of the invention, the method can also include requesting feedback from the first party and the second party regarding the sale and purchase of the at least one good.

### BRIEF DESCRIPTION OF DRAWINGS

In the drawings, like reference characters generally refer to the same or similar parts throughout the different views. Also, the drawings are not necessarily to scale, emphasis instead generally being placed upon illustrating the principles of the invention.

FIG. 1A is a flow diagram of an embodiment of a method for purchasing and selling goods via mobile computing devices connected to a communications network.

FIG. 1B is a flow diagram of another embodiment of the method of FIG. 1A.

FIG. 1C is a flow diagram of another embodiment of the method of FIG. 1A.

FIG. 2 is a flow diagram of a method of selling a good via mobile computing devices connected to a communications network.

FIG. 3 is a flow diagram of a method of buying a good posted for sale via mobile computing devices connected to a communications network.

FIG. 4 is a flow diagram of a registering for a subscriber account via mobile computing devices connected to a communications network.

FIG. 5 is a flow diagram of a method for searching for an item posted for sale via mobile computing devices connected to a communications network.

FIG. 6 is a diagram of a database server.

FIG. 7 is a perspective view of mobile computing devices connected to a communications network.

### DESCRIPTION

In general, the invention relates to methods and systems for purchasing and selling goods via mobile computing devices in order to create wireless marketplace by means of various wireless messaging paradigms.

In the discussion that follows, the term “seller” refers to a user of a first mobile computing device offering a good for sale, and the term “buyer” refers to a user of a second mobile computing device purchasing a good for sale. In addition, the term “user” refers to an individual accessing a service or system of the communications network.

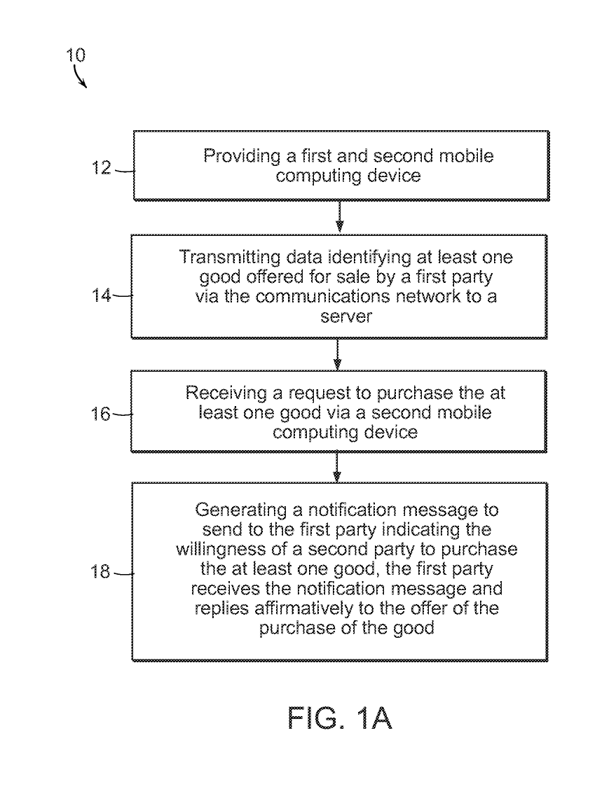

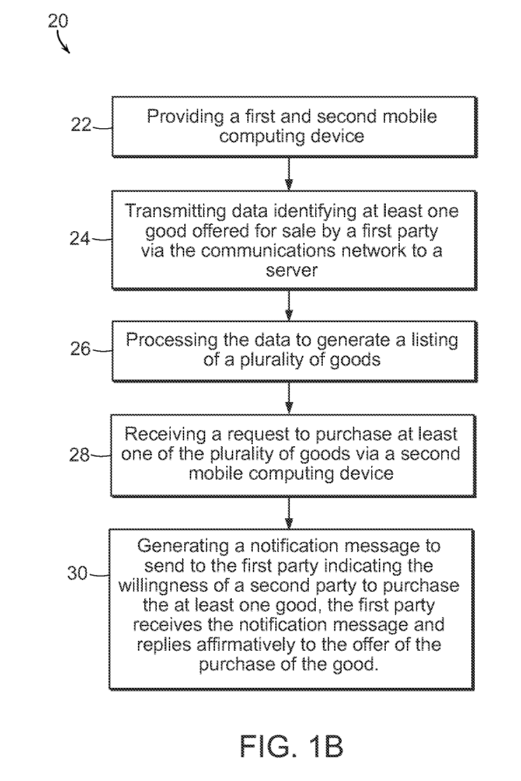

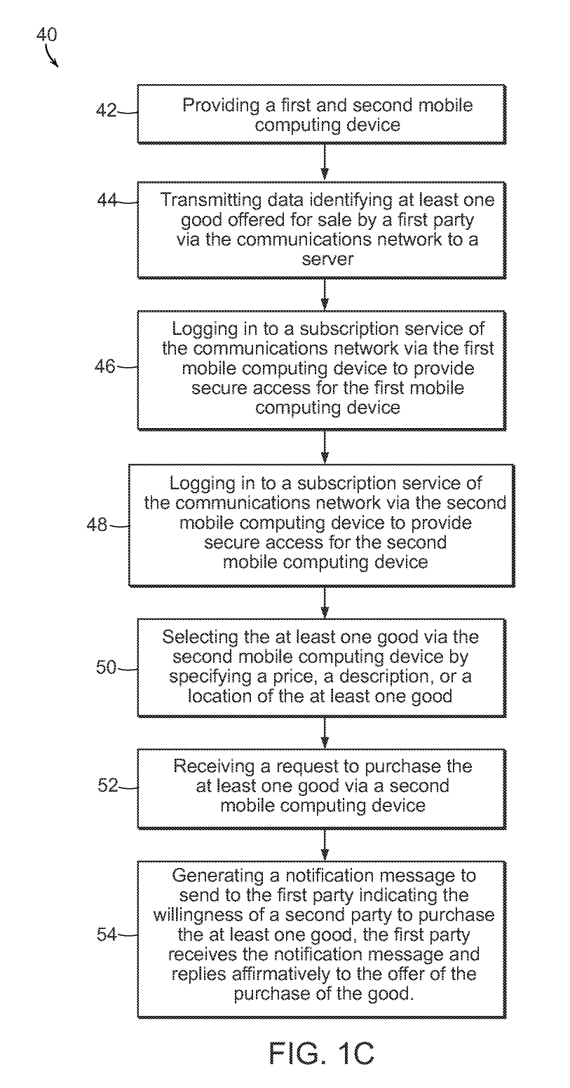

Referring to FIG. 1A, in one embodiment according to the invention, a method 10 of purchasing and selling goods through mobile computing devices that are connected to a communications network is presented. The method 10 includes a step 12 in which each of a first mobile computing device and a second mobile computing device has a user interface component for displaying data. The data received from the first mobile computing device identifies at least one good offered for sale by a first party. The data is displayed to the first party through a mobile computing device. The first party may change, update, or delete the data at any time via the first mobile computing device. In one embodiment, each of the first and second mobile devices can be selected from a group consisting of a mobile phone, a smart phone, a personal digital assistant, a web-based mobile client, and a wireless application protocol client.

At a step 14, the data identifying at least one good offered for sale by the first party is transmitted through the communications network to a server. The server includes a central processing unit, a memory connected to the central processing unit, and a data storage medium for storing the data.

At a step 16, the server receives a request to purchase the at least one good via the second mobile computing device. At a step 18, a notification message is generated and sent to the first party indicating the willingness of a second party to purchase the at least one good offered for sale. The first party then receives the notification message and replies affirmatively to the offer of the purchase of the good. The notification message can be a short message service message, a wireless application protocol message, or a world-wide-web based message.

The method 10 can also include a step of removing the at least one good offered for sale from the communications network. In addition, the method 10 can include a step of requesting feedback from the first party regarding the sale of the at least one good. Further, the method 10 can include a step of requesting feedback from the second party regarding the purchase of the at least one good. The method 10 can also include a step of selecting the at least one good by specifying a price, a description, or a location of the at least one good.

Referring to FIG. 1B, in another embodiment according to the invention, a method 20 of purchasing and selling goods through mobile computing devices that are connected to a communications network is presented. The method 20 includes a step 22 in which each of a first mobile computing device and a second mobile computing device has a user interface component for displaying data. The data received from the first mobile computing device identifies at least one good offered for sale by a first party. The data is displayed to the first party through a mobile computing device. In one embodiment, each of the first and second mobile devices can be selected from a group consisting of a mobile phone, a smart phone, a personal digital assistant, a web-based mobile client, and a wireless application protocol client.

At a step 24, the data identifying at least one good offered for sale by the first party is transmitted through the communications network to a server. The server includes a central processing unit, a memory connected to the central processing unit, and a data storage medium for storing the data. At a step 26, the server processes the data to generate a listing of a plurality of goods being offered for sale.

At a step 28, the server receives a request to purchase at least one of the plurality of goods via the second mobile computing device. At a step 30, a notification message is generated and sent to the first party indicating the willingness of a second party to purchase the at least one good offered for sale. The first party then receives the notification message and replies affirmatively to the offer of the purchase of the good. The notification message can be a short message service message, a wireless application protocol message, or a world-wide-web based message. The method 20 can also include a step of removing the at least one good offered for sale from the communications network.

Referring to FIG. 1C, in another embodiment according to the invention, a method 40 of purchasing and selling goods through mobile computing devices that are connected to a communications network is presented. The method 40 includes a step 42 in which each of a first mobile computing device and a second mobile computing device has a user interface component for displaying data. The data received from the first mobile computing device identifies at least one good offered for sale by a first party. The data is displayed to the first party through a mobile computing device. In one embodiment, each of the first and second mobile devices can be selected from a group consisting of a mobile phone, a smart phone, a personal digital assistant, a web-based mobile client, and a wireless application protocol client.

At a step 44, the data identifying at least one good offered for sale by the first party is transmitted through the communications network to a server. The server includes a central processing unit, a memory connected to the central processing unit, and a data storage medium for storing the data.

At a step 46, the first party can log in to a subscription service of the communications network via the first mobile computing device to provide secure access for the first mobile computing device. At a step 48, the second party can log in to a subscription service of the communications network via the second mobile computing device to provide secure access for the second mobile computing device.

At a step 50, the second party selects at least one good via the second mobile computing device by specifying a price, a description, or a location of the at least one good.

At a step 52, the server receives a request to purchase at least one of the plurality of goods via the second mobile computing device. At a step 54, a notification message is generated and sent to the first party indicating the willingness of a second party to purchase the at least one good offered for sale. The first party then receives the notification message and replies affirmatively to the offer of the purchase of the good. The notification message can be a short message service message, a wireless application protocol message, or a world-wide-web based message. The method 40 can also include a step of requesting feedback from the first party and the second party regarding the sale and purchase of the at least one good.

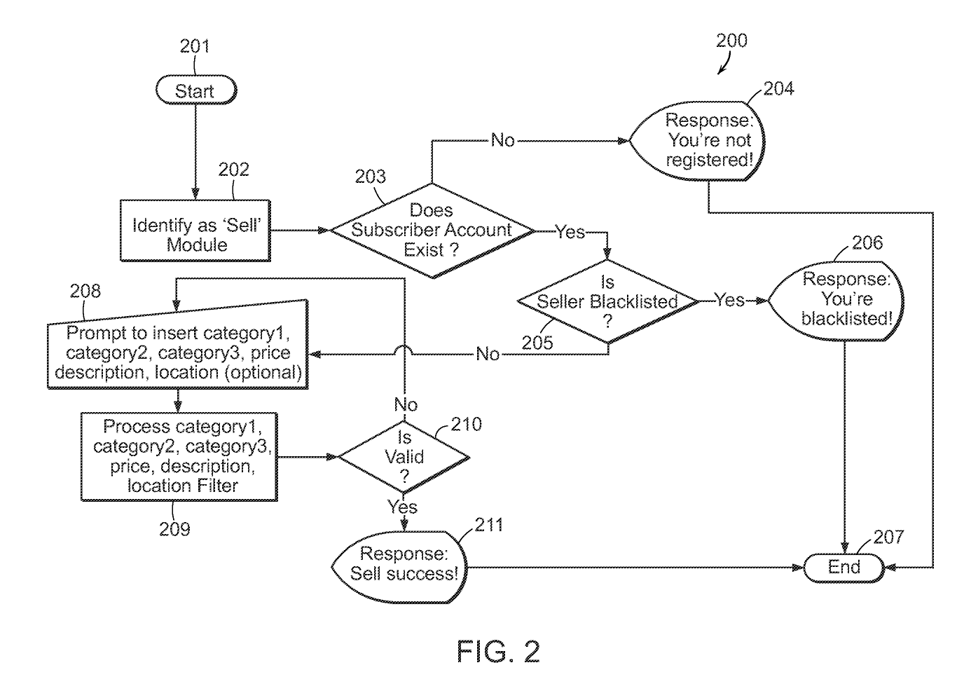

Referring to FIG. 2, a method 200 of selling goods via mobile computing devices connected to a communications network is presented. The method 200 includes a step 201 in which a first party can log in to service of the communications network. At a step 202, the first party identifies themselves as a seller of a good. At a step 203, the service determines if the first party has previously created an account with the service. If the first party has not created an account, the party is proceeds to a step 204 in which they are presented with a response stating that the party is not registered with the service. The first party then exits the service at a step 207. In the event the service determines that the first party has previously registered, the first party proceeds to a step 205 in which the service determines if the first party is prohibited from acting as a seller. If the first party is prohibited from acting as a seller, the first party proceeds to step 206 in which they are presented with a response stating that the party is prohibited from acting as a seller. The first party then exits the service at a step 207. If a first party is not prohibiting from acting as a seller, the party proceeds to a step 208.

At step 208, the first party is prompted to insert their good's category, price, description, and optionally the good's location. At step 209, after the first party inputs the information, the service processes the information. At step 210, the service determines if the information regarding the good is valid. At step 211, after verification from the service, the first party waits for a response that the good is sold.

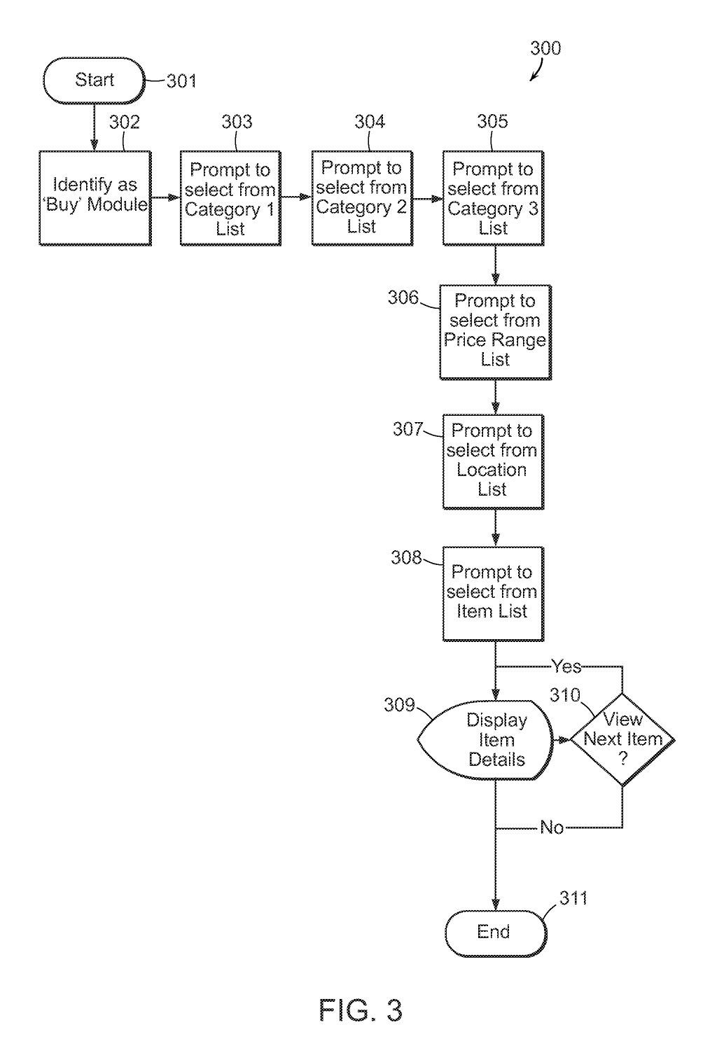

Referring to FIG. 3, a method 300 a method of buying a good posted for sale via mobile computing devices connected to a communications network is presented. A second party or a buyer uses their mobile phone to search for goods that they wish to purchase. Buyers have the option of optimizing their search by price and proximity. Once a buyer identifies a compelling item, the buyer can use their mobile device to contact the seller and close the deal via a messaging paradigm such as a short messaging service message.

The method 300 includes a step 301 in which a second party can log in to the service of the communications network. At a step 302, the second party identifies themselves as a buyer. At steps 303 through 305, the buyer can select various categories from which to select a specific good. At a step 306, upon selecting the various categories, the buyer specifies a price range for the good of interest. Subsequently, at a step 307, the buyer selects a location of the good from a list of goods offered for sale. At a step 308, after the selection process, the buyer prompts the service to select a specific good, and at a step 309, the buyer views the specific details of the good. The buyer may choose to view a different good at a step 310 or their process at a step 311.

In one embodiment, methods of the invention include the following steps to complete a transaction: a seller posts a good for sale through the service, a buyer searches for and selects the good for purchase, the transaction is handled off-line, the seller removes the good for sale, the seller provides feedback on the buyer, and the buyer provides feedback on the seller. The system of the invention can maintain either party's identification, which includes a login name, password, transaction history, and buyer/seller rating that reflects feedback from counterparts in previous transactions. When either party logs in to the service, the service can (a) keep track of the transaction history of the parties and (b) customize a buyer's interaction or experience with the service. After logging in to the system, either party may pick between posting an item to sell or search for an item to buy (i.e. the party may select if they would like to be a buyer or a seller.) Both the sellers and the buyers use login and password identification each time they want to use the system, protecting the party's privacy and identity. In an embodiment, the invention deploys industry standard identity management and authentication tools.

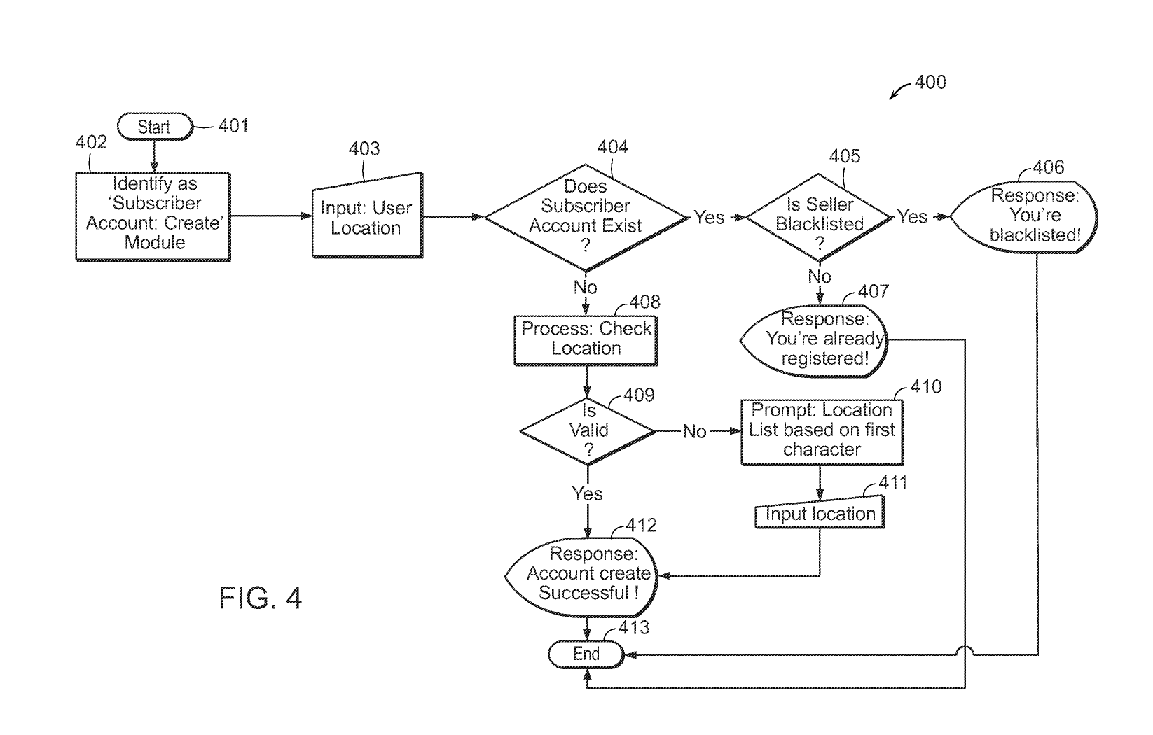

Referring to FIG. 4, a method 400 of a registering for a subscriber account via mobile computing devices connected to a communications network is presented. The method 400 includes a step 401 in which a user can access a subscriber account. At a step 402, the user identifies themselves as a subscriber, and at a step 403, inputs their geographic location. Similar to steps 203-205 of FIG. 2, steps 404-407 of the method 400 also determine whether a user is a registered user or is prohibited from acting as a seller. At step 408, if a subscriber account does not exist, the service will process the location information provided by the user at step 403. At a step 412, the service will create an account if the information is deemed to be valid. The user will be directed to steps 410 and 411 if the information provided is not valid or recognized by the service.

As a seller, in posting an item, the user may elect a product category and also enter in key details such as the quantity, price, location, preferred contact method, and the number of days to list the item, along with the prices for each. In purchasing an item, the user can browse for items from the home page or after logging in.

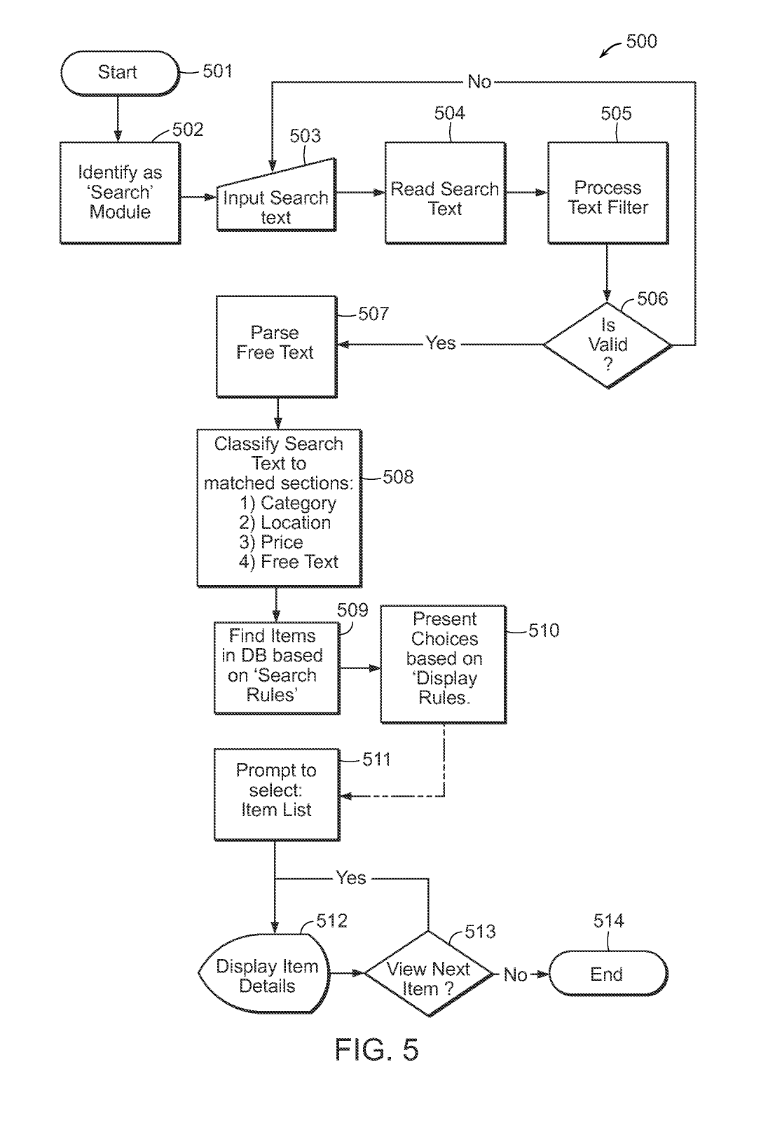

Referring to FIG. 5, a method 500 for searching for an item posted for sale via mobile computing devices connected to a communications network is presented. The method 500 includes a step 501 in which a user can access the service of the communications network. At a steps 502-505, the user can search the system for specific items by identifying a search module, inputting search text, and read and process the search text information. At a step 507, the service determines whether the search text information is valid. In the event the information is not valid, the user is returned to step 503. If the information is valid, the search text information is parsed by the service at step 507. At step 508, the user may further refine the search criteria to match up to different sections such as: category, location, price, and free text. At a step 509, the item will then be found in the database based upon the rules entered by the user. The service displays the results to the user at step 510. At steps 511 and 512, the user is prompted to select the item from the list and the service displays the item details. At step 513, the user may choose to view the next item that matches the rules entered, or the user may choose to end their search session at step 514.

In one embodiment of the invention, the user can search by item, price, or location. The user can then refine the search by the other criteria. For example, the user may search for a good such as rice and apply a filter based on rice sellers within a 25 km radius of his/her geographic location. The service may then list items in order from lowest to highest price. The user highlights the item, and then clicks the “select” option to initiate contact with the seller. Depending on the seller's preferred mode of contact, the system will, for example, either initiate a phone call or send a text message, and then the seller and the buyer will arrange the transaction offline.

The seller can remove or adjust the listing at any time prior to the expiration date selected. The user can also lower the available quantity or reduce the remaining time the item will remain listed. The seller cannot add to the quantity or extend the time the item will remain listed.

In various embodiments of the invention, methods can be provided to include a step of providing feedback regarding both the buyer and the seller. The seller can provide feedback on a buyer at any point after the buyer has selected the item and initiated contact with the seller. For example, the feedback may consist of a simple rating of one to three stars where three, two and one star consecutively suggests excellent, good and poor performance respectively. The buyer can also provide similar feedback on a seller after the buyer has adjusted the listing or after the listing has expired.

Additionally, the system can be available through short message service which makes the service completely handset independent. Further, the methods and system of the invention can work on at least three synchronized platforms: Short Message Service (SMS), Wireless Application Protocol (WAP), and the World Wide Web (WEB). SMS is a communications protocol allowing the interchange of short text messages between mobile telephone devices and works on even the most basic phones. A single text message size for SMS can be 160 7-bit characters, 140 8-bit characters, or 70 16-bit characters. WAP is an open international standard for applications that use wireless communication and is an easy, graphic interface. WAP's main use is to enable access to the Internet from a mobile phone or PDA. WEB is a system of interlinked hypertext documents contained on the Internet and is viewable by a global audience.

Further, the user interface of the mobile devices can also employ graphical icons to guide user actions such as Post, Browse, etc., and to categorize products such as those agriculture, household appliances or services such as standard classified services. The user interface allows posting pictures of any type of items users might want to sell, such as used equipment or television sets.

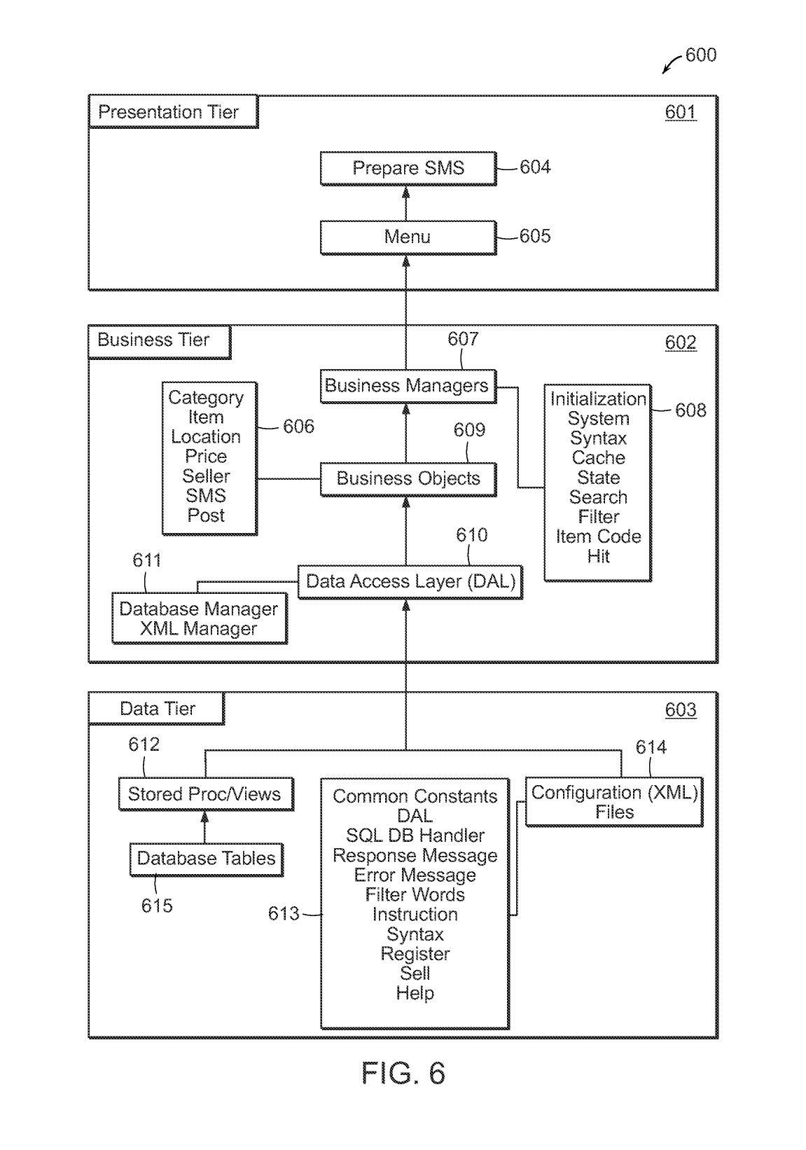

Referring to FIG. 6, a diagram of a database server 600 is presented. The server 600 consists of three tiers: a presentation tier 601, a business tier 602, and a data tier 603. The presentation tier 601 includes an SMS message 604 and a menu 605. In the menu 605, the user may choose to prepare and display an SMS message 604 for communication regarding the item. In the business tier 602, a first table 606, a business manager 607, a second table 608, a business object 609, and a data access layer 610 are presented. In the data tier 603, a view table 612, a function table 613, a configuration table 614, and a database table 615 are presented.

In one embodiment of the invention, the system consists of two components: a mobile phone client and a central server. The users conduct transactions on the client and connect to the server for processing. In another embodiment of the invention, users from the outset will have the option to access the marketplace via the Internet, and the company can adapt to changes in technology infrastructure quickly.

The server can consist of three layers: the display or presentation server tier 601, business rules tier 602, and the data backend tier 603. The database backend 603 may be a commercially available database server used to store all the relevant data for the service's daily operations. The business rules 602 serve as the intermediary between the database backend and the display server. This layer interprets the user questions and translates them into database queries, pulls the data, and presents it to the user. The presentation server 601 is responsible for transmitting the data from and to the client.

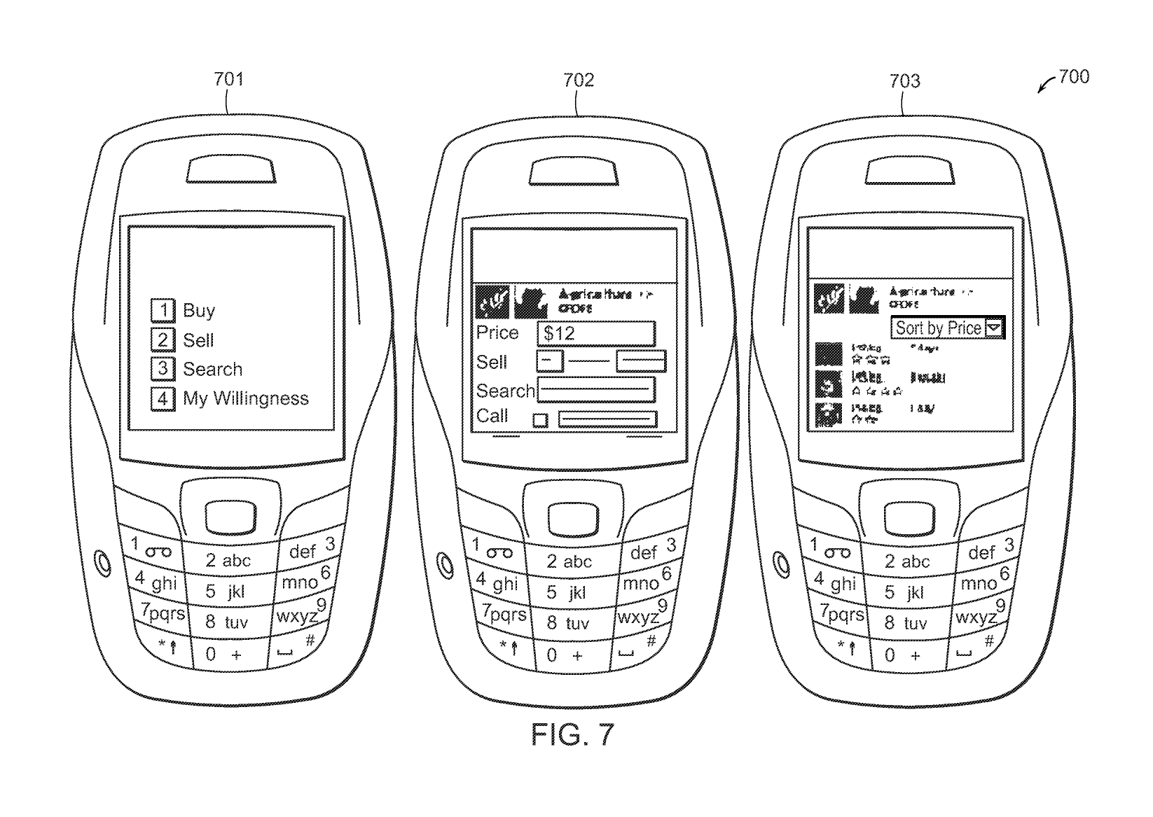

Referring to FIG. 7, a perspective view of a mobile computing device 700 connected to a communications network is presented. FIG. 7 depicts three separate screen shots of a seller logging in to a setup screen 701, selecting the item he wants to sell at screen 702, and setting the price and quantity of the item for sale at screen 703, all while using the mobile computing device 700.

Users access the service through a mobile client that interacts with the server. In one embodiment of the invention, the mobile phone client is a Wireless Application Protocol (WAP) service. In another embodiment of the invention, the mobile phone client is a Java application. Both the WAP service and Java application are supported by a wide variety of handsets and vendors.

The WAP service enables the application to run without installation on individual handsets, and therefore provides greater control over the display of the graphical user interface. While the Java application enables the application to run faster because it does not require downloading icons from the server each time the application is accessed. However, it does require the application to be downloaded and installed when new versions are released.

It will be understood that various modifications may be made to the embodiments disclosed herein. Therefore, the above description should not be construed as limiting, but merely as exemplifications of the various embodiments of the present disclosure. Those skilled in the art will envision other modifications within the scope and spirit of the claims appended hereto.

What is claimed is:

1. A method of purchasing and selling goods via mobile computing devices connected to a communications network, the method comprising:
providing a first mobile computing device and a second mobile computing device, each of the first mobile computing device and the second mobile computing device having a user interface component for displaying data, the data identifying at least one good offered for sale by a first party;
transmitting the data via the communications network to a server, the server including a central processing unit, a memory connected to the central processing unit, and a data storage medium for storing the data;
receiving a request to purchase the at least one good via the second mobile computing device; and
generating a notification message to send to the first party indicating the willingness of a second party to purchase the at least one good, the first party receiving the notification message and replying affirmatively to the request to purchase the at least one good.

2. The method of claim 1, wherein each of the first mobile computing device and the second mobile computing device is selected from a group consisting of: a mobile phone, a smart phone, a personal digital assistant, a web-based mobile client, and a wireless application protocol client.

3. The method of claim 1, wherein the notification message is a short message service message.

4. The method of claim 1, wherein the notification message is a wireless application protocol message.

5. The method of claim 1, wherein the notification message is a world-wide-web based message.

6. The method of claim 1, further comprising removing the at least one good offered for sale from the communications network.

7. The method of claim 1, further comprising requesting feedback from the first party regarding the sale of the at least one good.

8. The method of claim 1, further comprising requesting feedback from the second party regarding the purchase of the at least one good.

9. The method of claim 1, further comprising logging in to a subscription service of the communications network prior to receiving the data from the first mobile computing device.

10. A method of purchasing and selling goods via mobile computing devices connected to a communications network, the method comprising:
providing a first mobile computing device and a second mobile computing device, each of the first mobile computing device and the second mobile computing device having a user interface component for displaying data, the data identifying at least one good offered for sale by a first party;
transmitting the data via the communications network to a server, the server including a central processing unit, a memory connected to the central processing unit, and a data storage medium for storing the data;
processing the data to generate a listing of a plurality of goods;
receiving a request to purchase at least one of the plurality of goods via the second mobile computing device; and
generating a notification message to send to the first party indicating the willingness of a second party to purchase the at least one good, the first party receiving the notification message and replying affirmatively to the request to purchase the at least one good.

11. The method of claim 10, wherein the notification message is a short message service message.

12. The method of claim 10, wherein the notification message is a wireless application protocol message.

13. The method of claim 10, wherein the notification message is a world-wide-web based message.

14. The method of claim 10, wherein each of the first mobile computing device and the second mobile computing device is selected from a group consisting of: a mobile phone, a smart phone, a personal digital assistant, a web-based mobile client, and a wireless application protocol client.

15. A method of purchasing and selling goods via mobile computing devices connected to a communications network, the method comprising:
providing a first mobile computing device and a second mobile computing device, each of the first mobile computing device and the second mobile computing device having a user interface component for displaying data, the data identifying at least one good offered for sale by a first party;
transmitting the data via the communications network to a server, the server including a central processing unit, a memory connected to the central processing unit, and a data storage medium for storing the data;
logging in to a subscription service of the communications network via the first mobile computing device to provide secure access for the first mobile computing device;
logging in to a subscription service of the communications network via the second mobile computing device to provide secure access for the second mobile computing device;
selecting the at least one good via the second mobile computing device by specifying a price, a description, or a location of the at least one good;
receiving a request to purchase the at least one good via the second mobile computing device; and
generating a notification message to send to the first party indicating the willingness of a second party to purchase the at least one good, the first party receiving the notification message and replying affirmatively to the request to purchase the at least one good.

16. The method of claim 15, wherein the notification message is a short message service message.

17. The method of claim 15, wherein the notification message is a wireless application protocol message.

18. The method of claim 15, wherein the notification message is a world-wide-web based message.

19. The method of claim 15, wherein each of the first mobile computing device and the second mobile computing device is selected from a group consisting of: a mobile phone, a smart phone, a personal digital assistant, a web-based mobile client, and a wireless application protocol client.

20. The method of claim 15, further comprising requesting feedback from the first party and the second party regarding the sale and purchase of the at least one good.
